(19) United States
(12) Patent Application Publication
(10) Pub. No.: US 2010/0112173 A1
(43) Pub. Date: May 6, 2010

(54) ADDITIVE TO LOW-ALCOHOL OR SOFT DRINKS AND METHODS OF CONDITIONING DRINKS

(75) Inventors: Vitaly Mikhailovich DOLYA, Minsk (BY); Nariman Khalilullaevich SULEJMANOV, Moscow (RU)

Correspondence Address: BROOKS KUSHMAN P.C., 1000 TOWN CENTER, TWENTY-SECOND FLOOR, SOUTHFIELD, MI, 48075, US

(73) Assignee: Vitaly Mikhailovich Dolya, Minsk (BY)

(21) Appl. No.: 12/609,867

(22) Filed: Oct. 30, 2009

(30) Foreign Application Priority Data
Aug. 21, 2007 (EA) 20070002225

(51) Int. Cl. C11B 5/00; A23L 2/52; C12H 1/00

(52) U.S. Cl. 426/544

(57) ABSTRACT

The invention relates to the brewing and non-alcoholic industry and specifically for production of beer, low-alcohol and alcohol-free drinks The “Antioxilen” additive for beer, alcohol-free drinks contains an organic selenium compound—di-(3,4)-methyldipyrazolylselenide (DMDPS)—and also succinic acid and salts thereof (ammonium succinate or sodium succinate) as an antioxidant. The method of conditioning (enriching) drinks involves increasing biological value, improving quality and contributing antioxidant, antitoxic and hepatoprotective properties to drinks, i.e. protective properties for a human organism by adding the above additive to the finished product (drink). The additive is added in the form of a dry mixture or a solution. The invention allows for improving biological value of the product (drink), taste and useful properties thereof and also extending the “life” thereof.

### BACKGROUND

1. Technical Field

The invention relates to the brewing and non-alcoholic industry and specifically for production of beer, low-alcohol and alcohol-free drinks.

2. Background Art

A drink additive comprising a mixture of lactulose, lactose, galactose and lysocime is known. When added to a finished liquid food product, the additive improves organoleptic and preventive properties of alcoholic and alcohol-free drinks. The additive, however, does not neutralize some harmful substances which are contained both in alcoholic and alcohol-free drinks due to the processes for producing the drinks It does not preclude absorption of these substances by a human organism, however, it contributes to neutralization and excretion thereof from the human organism as shown in RU Patent No. 2217009 C2, dated 16 Nov. 2001, published 27 Nov. 2003.

A method has been proposed for improving biological value of beer by adding extracts of remedial herbs to the finished beer, specifically an aqueous alcoholic extract of hill-growing saltwort containing an extensive range of useful substances as shown in RU Patent No. 2162883 C2, dated 30 Dec. 1998, published 10 Feb. 2001. The disadvantage of this method is that adding an aqueous alcoholic extract to the finished beer or at the state of the secondary fermentation thereof reduces stability and foaming properties of the beverage.

The method of improving biological value of beer by preparing an organic selenium compound followed by adding it to the finished beer is the method closest to that claimed as shown in RU Patent No. 2209237 C2, dated 04 Nov. 2000, published 27 Jul 2003. The organic compound is prepared by mixing sodium selenite with ascorbic acid with a molecular ratio of 1:2. The disclosed process method allows biologically active beer with hepatoprotective and antioxidant properties to be produced.

This prototype, however, has a disadvantage which may substantially affect a human organism during lengthy ingestion of the biologically active beer enriched with inorganic selenium and ascorbic acid.

It is common knowledge that the process of biotransformation of selenium inorganic compounds into organic compounds proceeds incompletely, i.e. a portion of inorganic selenium is not transformed into an organic compound. It is a commonly-known fact that specifically selenium inorganic compound not only is poorly absorbed, but also forms highly toxic hydrogen selenide in a human organism as shown in A. V Tuteliyan. Selenium and Its Role in Metabolism of a Human Organism, M, 2002, I. V. Sanotsky. Selenium Compounds and Health, M., 2004, pp. 43-59, N. A. Golubkina, A. V. Skalny. Selenium in Medicine and Ecology, M., 2002, and V. G. Rebrov, O. A. Gromova. Vitamins and Microelements, M., 2003.

This prototype also has a disadvantage related to the method of adding an additive of the selenium organic compound since a selenium-containing compound is added to the wort before fermentation resulting in the yeast biochemical stimulation and growth, i.e. increase in the yeast cells which exceeds allowable standards—not more than 500 CFU/l—subject to requirements of Sanitary Rules and Standards 2.3.2.1078-01, thereby lengthening and complicating the process.

### SUMMARY

The object of this invention related both to preparing the additive and to the method for enriching (conditioning) the drink is to produce a new comprehensive Antioxilen additive for alcohol-free and low-alcohol drinks, specifically for beer, gin tonic and refreshment drinks This additive comprises a powerful natural antioxidant which increases biological value of the drink, contributes nice flavor thereto and improves antioxidant protection of a human organism against oxidative stress-related free radicals.

It is common knowledge that various vitamins such as A, E and C vitamins, quertecine, catechines, bioflavonoids and selenium are related to antioxidants. It should be pointed out that organic bivalent selenium—the DMDPS with a trade name Selekora S—is characterized by the most powerful antioxidant property among selenium compounds.

The method of improving biological value, i.e. conditioning (enriching) involves adding a selenium-containing food additive to the finished product prepared by premixing the additive with a finished beer in the ratio of 1:30000, low-alcohol drink such as gin tonic—1:20000 and alcohol-free drink—1:40000. According to guidelines of the Research Institute of Nutrition, Russian Academy of Medical Sciences, enriching foods with selenium should not exceed 20-30% of the daily requirement—55-75 μg, i.e. the quantity of the selenium-containing compound in terms of selenium should be within the interval of 5-100 μg/l. The invention allows for producing the drinks specifically with the above selenium content and improved biological value.

### DETAILED DESCRIPTION

An organic bivalent selenium compound is used in the composition with succinic acid or succinic acid salts, in particular, ammonium succinate or sodium succinate, as a natural antioxidant in the additive to improve biological value of beer and also to inhibit oxidative processes in the beer itself and build-up of free radicals and, hence, aging and souring of a product, with the ratio of ingredients being as follows, % by weight (alternatives I and II):

Alternative I:

| | |
|---|---|
| Selenium-containing organic compound | 0.20 |
| (in terms of selenium), not more than | |
| Succinic acid | the remainder |

Alternative II

| | |
|---|---|
| Selenium-containing organic compound | 0.20 |
| (in terms of selenium), not more than | |
| Succinic acid salt (ammonium succinate or sodium | the remainder |
| succinate) | |

Adding such a composition of ingredients to beer, alcohol-free and low-alcohol drinks improves biological value of a drink, maximizes antioxidant, hepatoprotective and anti-toxic effects, including protection of a human organism against the free radicals and other damage effects (presence of highly volatile toxic compounds such as carbon monoxide, heavy metals, etc. in the environment).

Adding selenium and succinic acid salts to beer significantly improves the beer biological value not only due to high biological activity of the bivalent organic selenium compound, but also due to high bioavailability thereof, with metabolism thereof being 85-95%.

Selenium as an essential microelement plays an important role in functioning of all organs and systems of a human organism and is in the composition of over 60 selenium-dependent enzymes.

Selenium deficiency induces cell damage, various diseases and nearly 75 different pathologies. Many countries—China, Finland, Germany and others—use inorganic selenium compounds.

Selenium plays a special role in prevention of toxic liver damage. Ingesting foods with a high peroxide index stimulates lipolytic processes in tissues. Lipid peroxides cause extensive damage in cells, their organelles and cell membranes resulting in disintegration of structures.

Selenium acts as a compound capable of reducing oxidation rate in cells and prevents lipids from overoxidation leading to formation of free radicals which, in their turn, inactivate enzymes and vitamins in the liver cells. However, using inorganic selenium compounds is harmful for a human organism and health. It is common knowledge that selenite and sodium selenate, as inorganic selenium compounds, are related to a category of highly toxic compounds—1 (first) class of hazard—extremely hazardous compound subject to GOST—12.1.007-76.

TABLE 1
Comparative Toxicologic Characteristics of Na₂SeO₃ and DMDPS
(inorganic and organic selenium compounds)

| Toxicometry parameters | Na₂SeO₃ | DMDPS (Selekor-S) |
|---|---|---|
| mg/kg | | |
| DL 50 m | 6 | 4,800-6,000 |
| DL 50 ks | 7-14 | 6,000-8,100 |
| Lim sub ch (30 days) | — | 400-800 |
| K sim (Limetal) | — | (>6) |
| K sim (according to Yu. S. Kogan) | (1.6) | (5) |
| MAC (human) | 0.1 mg/m³ | — |
| ADI (human) | 0.7 μg/kg | >20 μg/kg |

As is seen from the Table, firstly, the organic selenium compound—DMDPS—used in the provided food additive “Antioxilen”, is related to safer selenium compounds—low-toxic compounds of the fourth hazard class according to Zaugolnikov Table.

Secondly, given increasing beer consumption as a “fashionable” low-alcohol drink by youth and even adolescents, specifically high accumulativeness (ability to accumulate) in a human organism is of particular hazard for human health.

Thirdly, even a moderately toxic organic selenium compound of the 2^{nd} and 3^{rd} classes of hazard (toxicity) induces formation of highly toxic hydrogen selenide in a human organism.

Recent research has demonstratively proven positive and less hazardous effect of organic selenium compounds in the doses over 20 μg/kg of the body weight on the human organism.

Therefore, the “Antioxilen” additive containing the bivalent organic selenium compound—DMDPS—(Selekor-S) has a higher biological activity and bioavailability for the human organism and also absolute safety from the point of view of a “human factor”, i.e. possible mistake of overdosing such a compound as selenium is. Maximum allowable concentrations (of the organic compound “Selekor-S” is 8,100 μg/kg compared to that of the inorganic selenium compound—0.1 mg/m³ (Table 1).

The “Antioxilen” food additive (alternatives I-II) performs multiple functions as a component of drinks, specifically, it detoxicates free radicals, significantly reduces accumulation (concentration) of toxic substances in blood and contributes superb flavor and useful properties to the beverages. This increases biological value of the drink and contributes antioxidant, hepatoprotective and antitoxic properties thereto.

Specific realization of this invention is illustrated by the following examples.

### EXAMPLE 1

To prepare one kilogram of the “Antioxilen” additive, a precise weight of the selenium-containing organic compound is taken, so that it contains not more than 2 grams of selenium in terms of selenium and 998 grams of succinic acid is weighed. Di-(3,4)-methyldipyrazolylselenide (DMDPS), trade name “Selekor-S” is used as the selenium-containing compound and succinic acid is used as food acid.

The additive ingredients in the above quantities are charged into a mixer and are stirred for 15-20 minutes to produce the “Antioxilen” additive of the following composition, % by weight:

Alternative I

| | |
|---|---|
| selenium-containing compound di-(3,4)- | 0.20 |
| methyldipyrazolylselenide (in terms of selenium), not | |
| more than, | |
| succinic acid | the remainder. |

The method of conditioning (enriching) with the “Antioxilen” additive resides in as described hereinafter.

A mother solution in the quantity of 0.5-1.0 kg per 30,000 liters of beer, 20,000 liters of gin tonic and 40,000 liters of drinking water or drinks is added to the finished drink—beer, gin tonic and water—stirred and bottled. Before using, the above quantity of the “Antioxilen” additive is dissolved in the ratio of 1:30 for beer, 1:20 for gin tonic and 1:40 for water in the finished drink and the prepared solution is poured into a vessel containing the finished drink.

### EXAMPLE 2

The “Antioxilen” additive (alternative II) is prepared as described in Example 1, but instead of succinic acid, salt thereof (ammonium succinate or sodium succinate) is used.

The additive of the following composition is prepared, % by weight, (alternative II):

Alternative I:

| | |
|---|---|
| selenium-containing compound di-(3,4)- | not more than 0.20 |
| methyldipyrazolylselenide (in terms of selenium), | |
| succinic acid salts (ammonium succinate or | the remainder. |
| sodium succinate) | |

The method of conditioning (enriching) a drink with the “Antioxilen” additive (alternative II) is realized as described in Example 1.

The lower limit of adding (enriching) the “Antioxilen” additive, i.e. 0.5 kg per 30,000 liters of beer, 20,000 liters of gin tonic and 40,000 liters of water and drinks, is conditioned by the fact that the level of biological value of the drink and also antioxidant and hepatoprotective effects would not be attained when it is added below this limit. The upper limit of adding (enriching) the “Antioxilen” additive, i.e. 1.0 kg for the same quantities of drinks, is conditioned by the fact that when the additive is added to the respective drink in the quantity exceeding 1 kg per 30,000 liters of beer, 20,000 liters of gin tonic and 40,000 liters of water and drinks, the daily intake of the selenium microelement and succinic acid or salts thereof may be exceeded.

The tasting results have demonstrated that the finished products comprising the “Antioxilen” additive (alternatives I-II) in the recipe thereof have good organoleptic properties, i.e. taste. The “Antioxilen” additive's physicochemical indicators and organoleptic properties comply with the requirements of the Sanitary Rules and Standards.

Therefore, when added to a drink in the amount of 20-30 μg and ingested by a person with 1 bottle of beer, drink and drinking water, the “Antioxilen” additive prevents selenium deficiency, inhibits aging, strengthens the immunity, prevents various diseases of a human organism related to deficiency of such most critical microelement as selenium is.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. An additive to low-alcohol or alcohol-free drinks containing antioxidant in the form of an organic selenium compound, food acid or food acid salts, characterized in that di-(3,4)-methyldipyrazolylselenide (DMDPS) is used as the organic selenium compound, while succinic acid is used as food acid with the following ratio of components, % by weight:

| | |
|---|---|
| di-(3,4)-methyldipyrazolylselenide | not more than 0.20 |
| (DMDPS) (in terms of selenium) | |
| succinic acid | the remainder. |

or succinic acid salts (ammonium succinate or sodium succinate) are used as the food acid salts with the following ratio of components, % by weight:

| | |
|---|---|
| di-(3,4)-methyldipyrazolylselenide | not more than 0.20 |
| (DMDPS) (in terms of selenium) | |
| succinic acid salt (ammonium succinate or | the remainder. |
| sodium succinate) | |

2. The method of conditioning (enriching) beer, gin tonic, drinking water or other drink by adding the additive according to claim 1 to the finished drink in the form of a dry mixture while stirring, on the basis of 0.5-1.0 kg per:
30,000 liters of beer;
20,000 liters of gin tonic;
40,000 liters of drinking water or other drink.

3. The method of conditioning (enriching) beer, gin tonic, drinking water or other drink by adding the additive according to claim 1 in the form of a dry mixture which is preliminary dissolved in the finished drink in the following ratios:
for beer—1:30;
for gin tonic—1:20;
for drinking water or other drink—1:40,
and as produced solution is added to the finished drink on the basis of as follows:
for beer—3 dal of solution per 30,000 liters;
for gin tonic—2 dal per 20,000 liters;
for drinking water or other drink—4 dal per 40,000 liters.
